(19) United States
(12) Patent Application Publication
(10) Pub. No.: US 2023/0275892 A1
(43) Pub. Date: Aug. 31, 2023

(54) AUTO-SWITCHING CONTENT BETWEEN DEVICES BASED ON MEETING CONDITIONS

(71) Applicant: Verizon Patent and Licensing Inc., Basking Ridge, NJ (US)

(72) Inventors: Satya Prakash Pati, Bangalore (IN); Santosh Holla K S, Bangalore (IN)

(21) Appl. No.: 17/680,737

(22) Filed: Feb. 25, 2022

(51) Int. Cl. H04L 9/40; G06F 3/14; G06V 40/16; G10L 17/06

(52) U.S. Cl. CPC H04L 63/0861; G06F 3/1454; G06V 40/172; G06V 40/166; G10L 17/06; H04L 63/0428

(57) ABSTRACT

Embodiments may involve periodically scanning, by a room system, a locale of the room system. The room system may be rendering media associated with a meeting of persons at the locale of the room system. Based on the scanning, it may be determined that a person at the locale is not authorized with respect to the meeting. Based on the determining, the room system may be instructed to stop rendering the media and user devices of the respective persons may be instructed to begin rendering the media.

### BACKGROUND INFORMATION

Sharing content by displaying it to a group of co-located people is a common activity. In a meeting room, for example, a wall display may be used by a presenter to show graphical content to participants of the meeting. It is not uncommon for a presenter to display sensitive media content such as financial data, business plans, medical research, new product information, personal information, and so forth. The sensitive content may be intended for a limited audience, such as all those invited to attend a meeting.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows a meeting system for managing the presentation of media during meetings.

FIG. 2 shows an implementation of a meeting server.

FIG. 3 shows an example of a room system.

FIG. 4 shows an example of a user device.

FIG. 5 shows a process performed by a meeting system.

FIG. 6 shows an example of a pre-meeting verification phase.

FIG. 7 shows a process for scanning the locale of a meeting to detect conditions relevant to privacy conditions of the meeting.

FIG. 8 shows a process for enforcing a privacy condition of a meeting.

FIG. 9 shows rendering of meeting media being shifted from a meeting room display to user devices of users authorized to attend the meeting.

FIG. 10 shows rendering of meeting media being shifted from user devices to a meeting room display.

FIG. 11 shows an example of a user interface for configuring privacy-enhanced meetings.

FIG. 12 shows examples of user interfaces for user devices.

FIG. 13 shows an example computing device.

### DETAILED DESCRIPTION OF EXAMPLE EMBODIMENTS

Currently, during a meeting, to prevent unwanted disclosure and potential dissemination of sensitive content, a meeting presenter may visually survey the attendees and if an interloper is noticed then the presenter may stop presenting the sensitive content, which disrupts the intended audience's viewing of the sensitive content. A presenter or moderator may be preoccupied and unable to prevent unauthorized attendance at a meeting where sensitive content is being electronically presented. When an unauthorized person is present at a meeting, it may be helpful to, with minimal disruption of the meeting, prevent unwanted disclosure of sensitive information during the meeting.

Embodiments described herein may relate to preventing unwanted disclosure of sensitive information during meetings while allowing the meetings to proceed without significant disruption. A meeting system may have a room system that may cooperate with a backend system. A meeting may be conducted at a locale of the room system, which may include a display and one or more sensing devices. The meeting system may maintain a set of identities (e.g., identities of persons) authorized to attend the meeting. The meeting system may be able to determine identities (e.g., identities of persons) present during the meeting based, for example, on scans of the locale of the meeting by the sensing devices. The attendees may have respective user devices that they are able to operate during the meeting. During the meeting, the meeting system may monitor the scans of the meeting locale and may determine whether there are any identities present at the meeting locale that are not in the list of authorized identities.

The meeting system may determine that an identity present at the meeting is not in the set of identities authorized to attend the meeting. The meeting system may respond by causing the room system to stop rendering content related to the meeting and by causing the user devices of authorized identities to begin rendering the content. While the user devices are rendering the content, the meeting system may continue to monitor the identities present at the locale of the meeting and determine if any unauthorized identities are present. If the meeting system determines that no unauthorized identities are present, then the meeting system may cause the content to stop being rendered by the user devices and resume being rendered by the room system. Consequently, persons not authorized to attend the meeting may be prevented from seeing or hearing content during the meeting and authorized attendees may see or hear content on their user devices. Authorized attendees make use of the room system to see or hear content when there are only authorized attendees present.

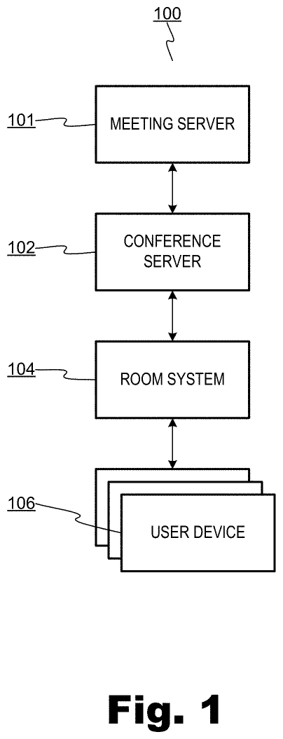

FIG. 1 shows a meeting system 100 for managing the presentation of media during meetings. A meeting server 101, a conference server 102, a room system 104, and a user device 106 (as used herein, “user device” is for clarity and does not imply any type of ownership; a user device may be any computing device operable by a person such as a person attending a meeting) are configured to communicate with each other through one or more networks (not shown). The meeting server 101 may perform several functions, including managing meetings. For example, the meeting server 101 may handle the creation of records of new meetings, maintain or access a database of persons who attend meetings, send meeting invitations to participants, and so forth. The meeting server 101 may also perform functions related to privacy of meetings, such as verifying attendees or their devices at meetings and determining whether they are authorized to participate, controlling the presentation of media during meetings based on privacy conditions associated with the meetings, and so forth. The conference server 102 may provide functions related to meetings, such as storing and providing keys related to meetings, streaming meeting content to the room system 104, and so forth. The room system 104 is located where a meeting takes place. The room system 104 may render media during a meeting, sense or scan in the vicinity of the meeting, and provide sensed information to the meeting server 101 to allow the meeting server 101 to manage privacy for the meeting. The user device 106 may be any computing device operated by a person who participates in a meeting. For example, a user device 106 might be a mobile phone, a laptop computer, a desktop computer, etc.

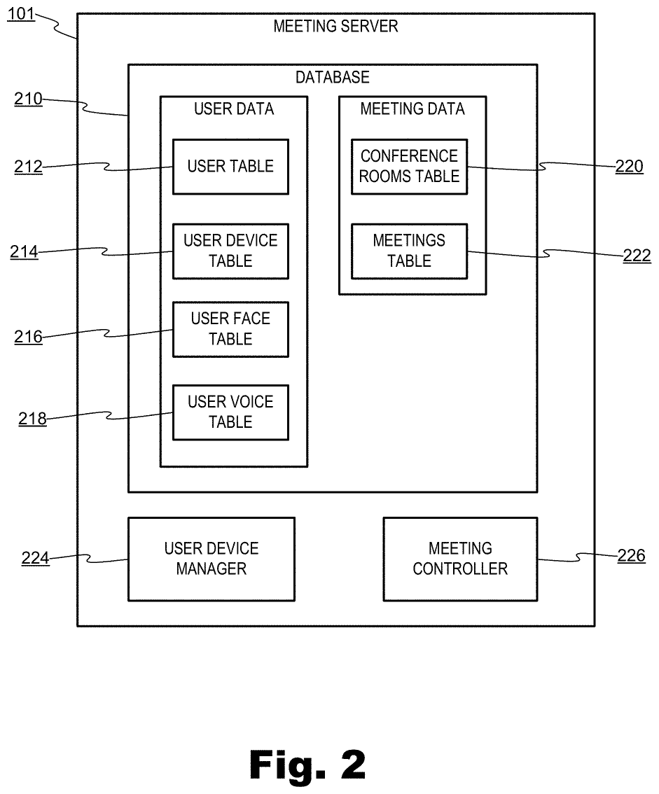

FIG. 2 shows an example implementation of a meeting server 101. As noted above, the meeting server 101 may manage meetings and provide privacy functionality for the meetings. The meeting server 101 may include a database 210. The database 210 may provide user-related data such as a user table 212, a user device table 214, a user face table 216, a user voice table 218, and so forth. The user table 212 may store records of respective persons who may participate in meetings. For example, a user table might store records of employees of an organization or of customers of a telecommunications provider. A user record may include information such as a user's name, contact information (e.g., email address), etc. The user device table 214 may be linked to the user table and may store records of user devices 106 of respectively associated users in the user table 212. A user device record may include information such as a device serial number, an indication of a device type, indicia of a device's configuration, a phone number, or the like. The user face table 216 and user voice table 218 may store records that include digital representations of respectively associated users' faces and voices. These records may be used to verify the voices and faces of users when they attend meetings by comparing intra-meeting face/voice captures with the digital representations stored in the database 210.

The database 210 may include meeting-related data such as a conference rooms table 220 and a meetings table 222. The conference rooms table 220 may store records of respective conference rooms, for example which room systems 104 are in which rooms or locations, attributes of rooms, and related information. Room records may be referenced by meeting records in the meetings table 222. The meetings table 222 stores records of respective meetings. A meeting record for a meeting may include information such as the time and room (or location) of the meeting, a set of persons authorized to attend the meeting, attributes of the meeting, privacy-related settings for the meeting, etc. In some embodiments, the rooms table 220 may store sets of privacy options for respective meeting rooms. As described below, when a meeting room is selected for a meeting, the associated set of privacy options may, for example, be presented on a user interface to allow a user to select privacy options suitable to the meeting room.

The meeting server 101 may also include software components such as a user device manager 224 and a meeting controller 226. The user device manager 224 may communicate with user devices 106 and may provide functions such as installing (or verifying installation of) a meeting application on user devices 106, determining if a given device is registered with a particular user (e.g., is in the user device table 214 and is associated with the user's record in the user table 212), adding user devices to the user device table 214, associating user devices with users, sharing keys with user devices, and others. The meeting controller 226 may perform various operations related to safeguarding the privacy of content shared during meetings, as described below.

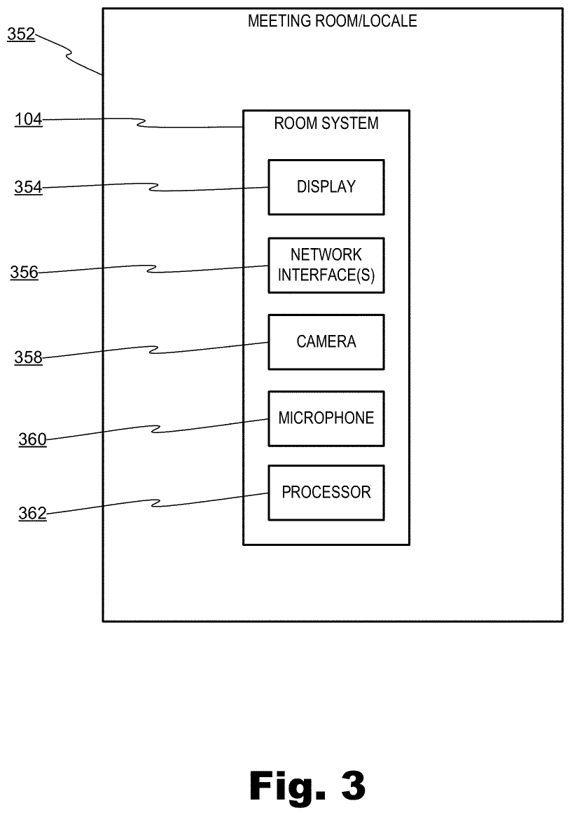

FIG. 3 shows an example of a room system 104. The room system 104 is located in a meeting room 352 or any locale for meetings. The room system 104 may include a display 354, one or more network interfaces 356 (e.g., wireless, cellular, Ethernet, etc.), a camera 358, a microphone 360, and a processor 362. These components cooperate to perform room-related meeting-privacy functions described herein. The components of the room system 104 may be part of a single computing device, several cooperating devices, etc. Some components may connect as peripheral devices of the processor 362. The camera 358 and microphone 360 are arranged to be able to capture video and audio data in the meeting room 352, which may be relayed via a network interface 356 to the meeting server 101. The display 354 may display meeting media during meetings. The room system 104 may include a loudspeaker for playing audio content during meetings (the loudspeaker may be part of the display 354). The meeting media may be provided from the conference server 102 to the room system 104. The conference server 102 may function as a media server and distributer by streaming media for any meeting. For example, when a moderator starts a meeting with content sharing, the conference server 102 may ensure that media (along with content) is distributed to clients (meeting rooms). In some embodiments, the meeting media may stream directly to the display 354. As described below, the processor 362 may control when the camera 358 or microphone 360 capture data and the processor 362 may send the captured audio/video data to the meeting server 101.

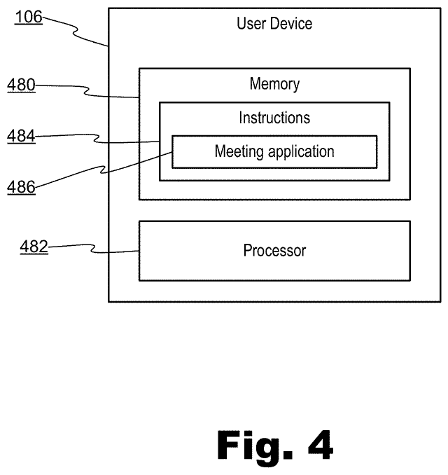

FIG. 4 shows an example of a user device 106. The user device 106 may include, without limitation, a memory 480 and a processor 482 selectively and communicatively coupled with one another. The memory 480 and the processor 482 may each include or be implemented by computer hardware that is configured to store and/or execute computer software. Various other components of computer hardware and/or software not explicitly shown in FIG. 4 may also be included within user device 106. In some examples, the memory 480 and the processor 482 may be distributed between multiple components, multiple devices, and/or multiple locations as may serve a particular implementation.

The memory 480 may store and/or otherwise maintain executable data used by the processor 482 to perform any of the functionality described herein. For example, the memory 480 may store instructions 484 that may be executed by the processor 482. Additionally, the memory 480 may also maintain any other data accessed, managed, used, and/or transmitted by the processor 482 in a particular implementation. The memory 480 may be implemented by one or more memory or storage devices, including any memory or storage devices described herein, that are configured to store data (excluding signals per se).

The instructions 484 may be executed by the processor 482 to cause the user device 106 to perform any of the functionality described herein. For example, the instructions 484 may include a meeting application 486 configured to perform any of the user device functions described herein, for instance rendering meeting media, capturing images/video, etc. More specifically, the processor 482 may be one or more general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), or the like. When the processor 482 performs operations according to the instructions 484, the user device 106 may perform various functions to enable the user to participate in a meeting via the meeting system 100 in any manner described herein.

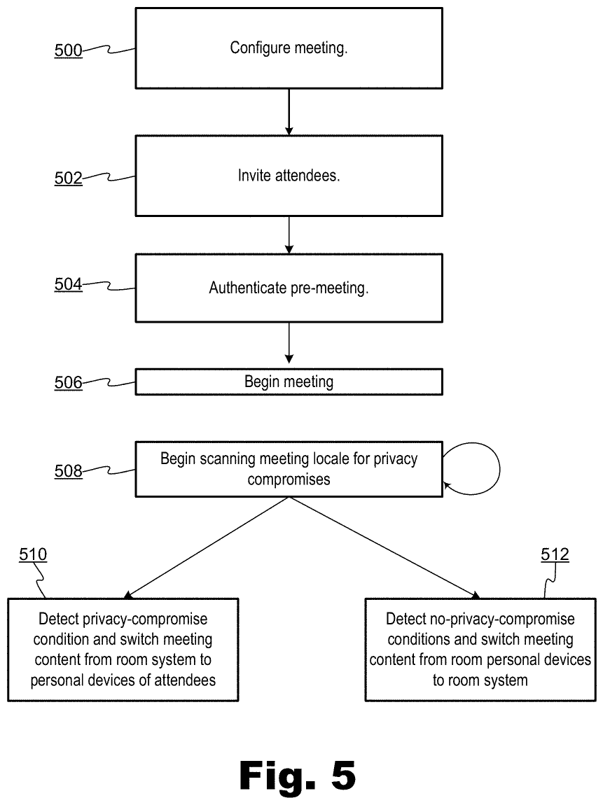

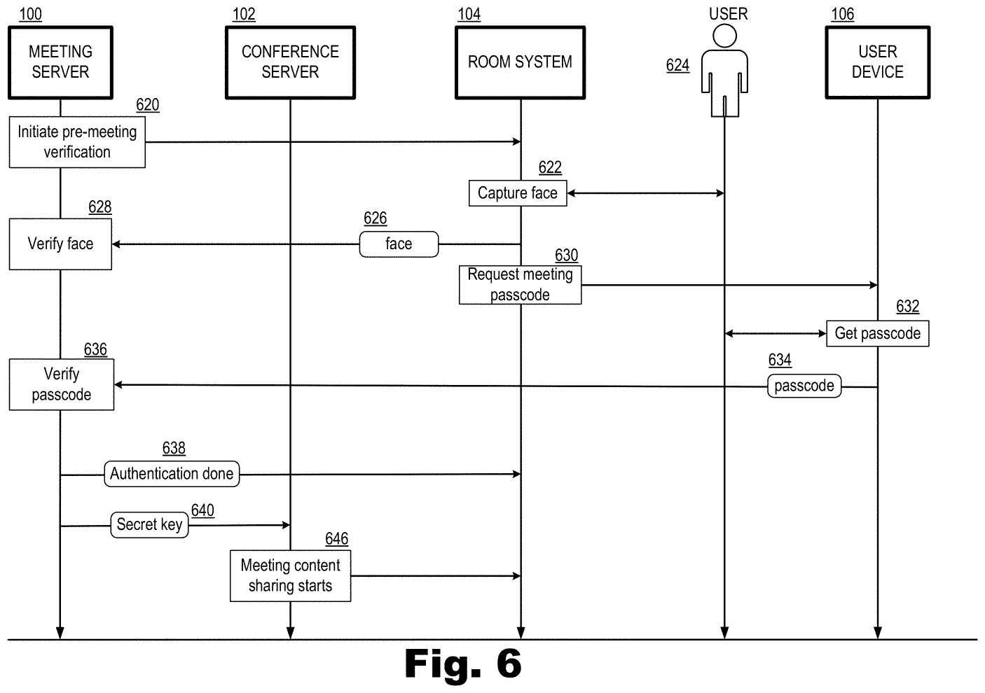

FIG. 5 shows a process that may be performed by the meeting system 100. While FIG. 5 illustrates exemplary operations according to one embodiment, other embodiments may omit, add to, reorder, and/or modify any of the operations shown in FIG. 5. One or more of the operations shown in FIG. 5 may be performed by the system 101, any components included therein, and/or any implementation thereof. Which components of the meeting system 100 may perform which operations of the process in certain implementations is described below with reference to FIGS. 6-8.

The process shown in FIG. 5 begins with a first operation 500 for configuring a new meeting. The meeting system 100 receives meeting parameters from a meeting organizer. The meeting parameters may include, for example, a meeting's time and location/room, privacy conditions for the meeting, which users are invited to the meeting, etc. As described below, the privacy conditions may include one or more conditions that are repeatedly evaluated during the meeting to determine whether a privacy-protecting operation is to be performed. Privacy conditions may include conditions such as: only faces of invited attendees are present at a meeting, only voices of invited attendees are present at a meeting, only known or paired user devices of invited attendees are present at a meeting, no user devices are allowed to use their cameras or microphones during the meeting, etc.

After the new meeting has been configured, a second operation 502 is performed by the meeting system 100 for inviting the attendees of the meeting. An invitation message may be sent to the attendees, for example by email, by instant messaging, etc. The invitation message may include a passcode for the meeting as well as any other information about the meeting.

The meeting system may then perform a third operation 504 for pre-meeting authentication. This operation may involve identifying persons present for the meeting and verifying that the identified persons are attendees invited to the meeting. The verification may be performed in any suitable way and may be used to verify that one or more privacy conditions are satisfied for the meeting. For example, images of the faces of persons in the relevant meeting room (or locale) may be captured by the camera 358 of the room system 104. Voices may be sampled by the microphone 360. Persons in the room or locale of the meeting may be verified by verifying their respective user devices. For example, the meeting application 486 on the user devices may be executed and the attendees may verify their user devices to the meeting system 100 by entering the passcode received in their invitations. The applications 486 may send the passcode to a backend device (e.g., the meeting server 101) which verifies that the passcode is correct. Any verification technique (or combinations thereof) may be used to identify persons near the appointed room system 104 and to assure that they have been invited to the meeting.

At a fourth operation 506, if all the persons present near the room system 104 have been verified as authorized invitees, then the meeting may begin. If media is being presented during the meeting, the media may be rendered by the room system 104 for the attendees to see or hear.

At a fifth operation 508, the room system 104 begins scanning the meeting locale for determining whether a specified privacy condition has been violated. The scanning may involve capturing images (e.g., images of faces) in the locale with the camera 358, sampling voices with the microphone 360, detecting devices in the locale using various wireless protocols such as a Bluetooth protocol, or others. Data captured during scanning may be sent to the meeting server 101, which checks the data against data previously stored in the database 210. For example, images of faces may be compared to faces of attendees stored in the face table 216, voices in recorded audio may be compared to stored voice samples in the voice table 218, identifiers of detected devices may be compared to the identifiers of user devices in the user device table 214 associated with attendees, etc.

At a sixth operation 510, when it has been determined that a privacy condition of the meeting has been violated, then the meeting system 100 directs any media being rendered by the room system 104 to (i) stop being rendered by the room system 104 and (ii) begin being rendered by the verified user devices of the attendees. Examples of switching media rendering from the room system 104 to the user devices 106 are described below. While the media is being rendered by the user devices 106, the room system 104 continues to scan the room or locale of the meeting. At a seventh operation 512, when it has been determined, per the ongoing scanning, that no privacy conditions are being violated with respect to the meeting, then the meeting system 100 may direct the media being rendered by the user devices 106 to (i) stop being rendered by the user devices 106 and (ii) start being rendered by the room system 104. The sixth and seventh operations 510 and 512 may be performed repeatedly during the meeting according to the scanning and privacy condition checking.

Regarding switching media rendering from the room system 104 to the user devices 106, when the meeting server's 101 sixth operation 510 detects a violation of a privacy condition the meeting server 101 may make a REST (representational state transfer) API (application programming interface) call to the conference server 102 to stop content streaming to the room system 104. The meeting server 101 may then send a push notification over a communication via websocket (for example) to the room system 104 indicating the reason for content stream interruption. The room system 104 may respond to the push notification by displaying a user interface indicating why content is blocked and indicating that users may resume viewing content on their user devices 106. The room system 104 may also start monitoring Bluetooth Low Energy (BLE) signal strength from the authorized user devices 106 in the meeting locale and repeatedly report, to the meeting server 101, a list of sensed devices along with respective detected proximity ranges. The meeting server 101 may assess minimum range criteria of the user devices 106 to determine which user devices 106 are or are not authorized to receive content. The meeting server 101 may correspondingly send push notifications to the authorized user devices 106 in the room about content availability. In addition, the meeting server 101 may make a REST API call to the conference server 102 providing a list of identifiers (e.g., serial numbers) of the user devices 106 to which content streaming is allowed. Upon receiving the push notifications on the user devices 106, if content viewing is allowed and is currently not started, a user may start viewing by clicking a link and identifying themselves (as described below). If content viewing is not allowed, a user may be notified that they are out of proximity and need to be closer to the meeting to resume viewing content.

Once a user device 106 and/or user is authenticated, the conference server 102 may start rendering media to user devices 106 by using, for example, HLS/RTMP (HTTP livestreaming/real-time media protocol). Which protocol is used may depend on latency conditions and the type of user device 106.

When the meeting server's 101 seventh operation 512 determines that no privacy condition is compromised, then the meeting server 101 may make a call (e.g. a REST API call) to the conference server 102 to re-start the content streaming to the room system 104. The meeting server 101 may also send push notifications to the authorized user devices 106 about availability of the content from the room system 104, to which the authorized user devices 106 may respond by displaying a user interface indicating the content is now available on the display 354 of the room system 104. In some embodiments, attendees may continue viewing content on their user devices 106 and the proximity monitoring may continue. In other embodiments, content may be automatically stopped at the user devices 106.

FIG. 6 shows an example of a pre-meeting verification phase. The steps shown in FIG. 6 may start from the point where a meeting has been configured and meeting attendees have received invitations. At a time near the scheduled start of a meeting (e.g., ten minutes before the scheduled start of the meeting), the meeting server 101 may initiate 620 the pre-meeting verification process by sending a message to the room system 104 to signal that pre-meeting verification is beginning. In response, the camera 358 of the room system 104 may capture 622 the face of a user 624 in the meeting locale. An image or video 626 of the face is sent to the meeting server 101. The meeting server 101 then verifies 628 the image or video by comparing it to the face imagery stored in the face table 216. If the face of the user matches the stored face image data associated with an invited attendee, then the user is authorized to attend. The same process may be repeated for all users present before the meeting), or the image or video 626 may include all of the present faces. Alternatively or additionally, voice samples of users may be captured, for example by prompting users to state their names, capturing that speech with the microphone 360, and sending the voice samples to the meeting server 101 for comparison to previously stored voice samples or signatures.

In further response to the pre-meeting notification from the meeting server 101, the room system 104 may request 630 the meeting passcode (previously included in the meeting invitation) from each user's user device 106. The user device 106 may execute the meeting application 486 on the user device 106 to request 632 the passcode. The user device 106 receives and then and sends the passcode 634 to the meeting server 101, which verifies 636 the passcode 634. This step may also implicitly verify that the meeting application 486 is installed on the user device 106. The room system 104 may also respond to the pre-meeting notification (or to receipt of the passcode 634) by requesting or initiating a wireless (e.g., Bluetooth or WiFi) pairing with the user devices of the attendees. For example, the room system's display 354 may display a Quick Response (QR) code and text asking each attendee to scan the QR code displayed on the display 354 using the meeting application 486. The meeting application 486 is then used to scan the QR code, which pairs the user device to the room system 104. The pairing may verify the proximity of user device 106 and prepare the user device for later rendering media of the meeting should a privacy condition be determined to be violated, as described below.

Another technique is to use the passcode verification process as the basis for determining a set of authorized attendees; any user who presents the correct passcode for the meeting is added to the set of authorized attendees. With this approach, faces or voices may be captured before the meeting for the purpose of monitoring for unauthorized voices or faces during the meeting. With this approach, a table of pre-existing voice samples, of face samples, or of associations between users and user devices may be obviated. During the meeting, any detected face or voice not captured and verified (per passcode submission) before the meeting can be deemed unauthorized.

When all of the users present before the meeting begins have been verified and determined to be authorized to attend the meeting, the meeting server 101 may send an authentication-complete message 638 to the room system 104. Note that pre-meeting authentication may ensure that the correct set of users are present in a meeting room when a meeting starts. If ten authenticated users were invited to the meeting and only eight turned up at the start of the meeting, then the moderator knows the attendance. Also, the pre-meeting authentication procedure may establish which devices can receive meeting content. For example, a user might be an authenticated attendee with an unauthenticated user device, in which case content will not be switched to the unauthenticated user device. In addition, the meeting server 101 may generate and send a secret key 640 (described below) to the conference server 102. The conference server 102 can then begin sending 646 meeting media to the room system 104, which renders the media for the meeting on the display 354 and/or through a speaker of the room system 104. The meeting media may be pre-stored on the conference server 102, streamed from a user device of an authorized attendee to the conference server 102, etc.

If any unauthorized users are determined by the meeting server 101 to be present before the meeting, the meeting server 101 may indicate to the conference server 102 that media may not be rendered by the room system 104 at the start of the meeting (and, as described below, the media may be sent to and rendered by the user devices). The secret key 640 may still be generated and shared but may not be used until there is a determination that only authorized users are present in the meeting.

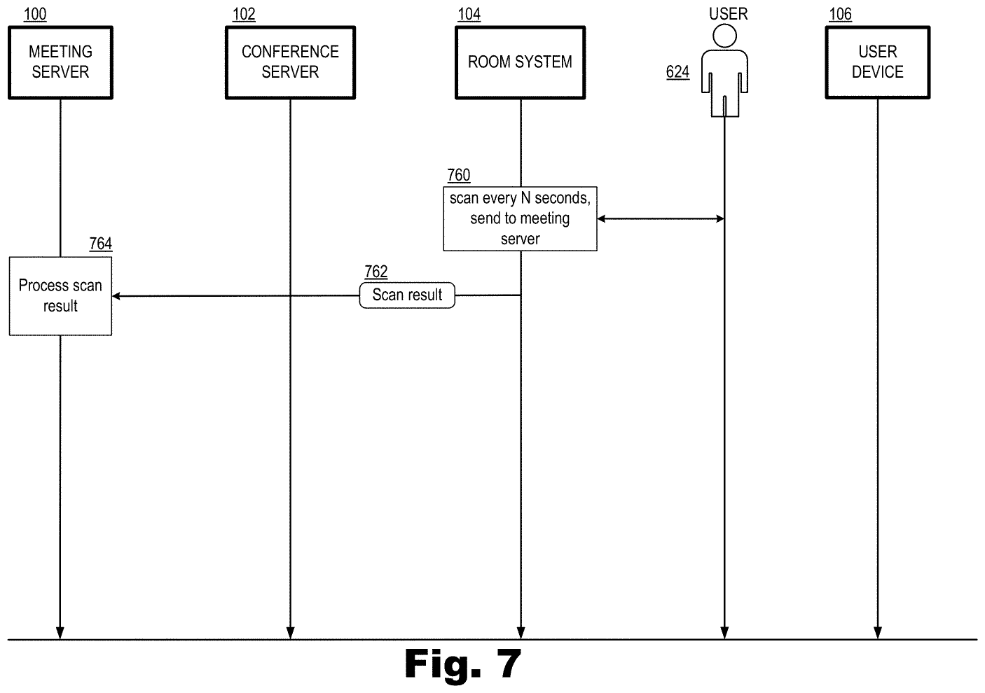

FIG. 7 shows a process for scanning the locale of a meeting to detect conditions relevant to privacy conditions of the meeting. The process shown in FIG. 7 may begin after the pre-meeting authentication process and may continue throughout the meeting. In some embodiments, the scanning process is only performed when media is being rendered by the room system 104. During the meeting, the room system 104 periodically scans 760 the meeting room or locale and sends the scan result 762 to the meeting server 101 for evaluation against the privacy conditions associated with the meeting. The scan period may depend on factors such as expected collective workload of the meeting system 100, sensitivity of the meeting, etc. In some implementations, the scanning period may be dynamic. For example, the room system 104 may scan for clues of potential changes in local conditions such as changes in the ambient noise level, changes in the number of faces detected in the meeting locale, changes in the number of devices transmitting radio signals (perhaps filtered by signal strength), etc. These signals can trigger a scan and sending the scan result 762 to the meeting server 101. The scanning may include capturing video or images of faces with the camera 358 and/or capturing audio with the microphone 360. The scanning may include listening for wireless beacons or replies to wireless probes. The scanning might include identifying any devices that are not paired with the room system 104 or are not associated with an authorized attendee. Any of the room system's sensors or network interfaces (radio) may be used to scan for conditions at the meeting. The scanning may include communicating with the meeting applications on the respective user devices of attendees to determine if any user devices are using their cameras or microphones.

The meeting server 101 receives and processes 764 the scan result 762 to extract or detect conditions that can be evaluated against any privacy conditions associated with the corresponding meeting. The extracted conditions may include images or video of faces, recordings of voices, indicia of devices, etc. In some implementations, the meeting server 101 may use image processing algorithms (or a machine learning model) to perform object detection and recognition to identify conditions such as types of activities or objects. For example, a recognized activity might be a person using a recording a device (or a writing instrument), or a recognized object type might be a recording device. As another example, if the scan result 762 includes images of the meeting, then any known face detection/recognition algorithm may be used to recognize faces in the image. For example, facial features extracted from a scan image may be compared with facial features of faces in the face table 216 to determine if any face in the scan result 762 includes any faces that do not match the face of an authorized attendee of the meeting. Similarly, a three-dimensional model (or three-dimensional features) of a face may be reconstructed from one or more images in the scan result 762 and compared to respective three-dimensional patterns stored in the face table 216.

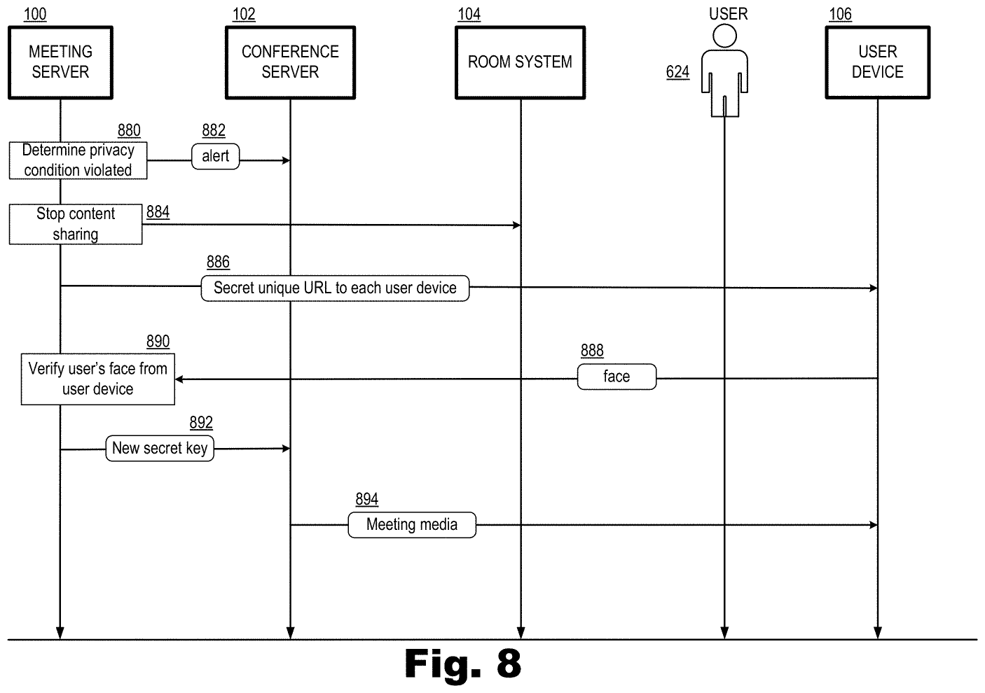

FIG. 8 shows a process for enforcing a privacy condition of a meeting. The process shown in FIG. 8 may follow the process shown in FIG. 7, which resulted in the meeting server 101 obtaining and processing a scan result 762. After obtaining a scan result 762 representing scanned meeting conditions, the meeting server 101 may determine 880 whether any privacy conditions configured for the meeting are being violated by any of the scanned meeting conditions. For example, if the meeting has a privacy condition of only allowing attendance by persons with authorized faces and an unauthorized face is determined to be present, then the privacy condition is determined to be violated. If there is a privacy condition that only authorized voices are permitted and an unauthorized voice is detected, then a violation is triggered. If only authorized user devices are permitted and an unauthorized device is detected, then that privacy condition is determined to be violated. A privacy condition may be that attendees must be within a certain distance of the meeting locale or meeting room display, which can be checked with image processing, signal strength of user devices, etc. Another condition might be a level of ambient noise. If the privacy conditions include a restriction on use of cameras or microphones, the meeting server 101 may check the scan result 762 for an indication of camera or microphone use. Yet another condition might be that a sound produced by a user device matches a known sound (e.g., a simulated camera click sound produced by a mobile device).

Further regarding audio-based privacy conditions, along with a table of users face data (e.g., photos), room system layouts, and user devices files, the meeting system 100 may also maintain, for detection, a list of objectionable background noises (e.g., camera-clicks or start-of-camera-recording) and abnormal lighting conditions. While doing repeated video scans the meeting system 100 may filter audio signals and perform pattern filtering and matching with an objectionable background list. This may be performed by a self-learning algorithm where the list gets updated once pattern matching is initiated and trained. A meeting moderator may then decide whether certain objectionable background noises are to be allowed or blocked for a particular meeting room, for example. In some cases, a meeting moderator may also decide to add objectionable lighting conditions parameters for a particular meeting room.

In certain embodiments, a privacy condition may be that only authorized persons are allowed to attend a meeting, and the meeting server 101 may use any of the types of conditions (voice, face, device, etc.) obtained from the scan to infer whether an unauthorized person is present. The meeting server 101 may maintain a set of authorized attendees and respectively corresponding data for identifying the attendees (e.g., pre-stored faces, voice data, device identifiers, etc.). If it is determined that the scan contains a face, voice, and/or device not associated with any of the authorized attendees, then the privacy condition is determined to be violated.

Each time meeting conditions of a meeting are obtained from a new scan, those meeting conditions are compared to the privacy conditions associated with the meeting. If the meeting server 101 determines 880 that any privacy conditions of the meeting are violated by any of the meeting conditions, then, if the meeting is not already in a privacy mode, the meeting enters the privacy mode. Conversely, as described below, if the meeting server determines that no privacy conditions are violated by any of the meeting conditions, then, if the meeting is in the privacy mode, the privacy mode is exited.

When the meeting server 101 determines to enter the privacy mode, entering the privacy mode may involve transferring the rendering of meeting media from the room system to user devices of attendees of the meeting. The meeting server 101 may send an alert 882 to the conference server 102 indicating that the meeting's media should be provided to the user devices of the meeting. The meeting server 101 may also signal the room system 104 to stop 884 rendering the meeting media. This signal may cause the room system to display a message (or provide some notification, such as playing a sound or the like) asking attendees to user their user devices to resume the meeting. The meeting server 101 may generate a unique identifier for each user device paired to the room system 104. For example, for each paired user device, the meeting server 101 may generate a key by generating a hash code of a combination of an identifier of the meeting and an identifier of the user device (e.g., a serial number or media access control (MAC) address). The hash code may be embedded in a uniform resource indicator (URI) that then serves as a device-specific secret unique key 886. The meeting server 101 sends the secret unique keys 886 to the respective user devices, for example by sending them to the room system, which sends them through the wireless-pairing connections to the meeting applications 486 of the user devices.

In response to the communications initiated by the meeting server 101, the meeting applications may scan the faces of the respective attendees and send the images/video of the faces 888 to the meeting server 101, which are then passed back through the room system to the meeting server 101. The meeting server may verify 890 the attendees' faces and determine that they are authorized. A new secret key 892 may be provided to the conference server 102, and the meeting media 894 is then streamed to the user devices of the attendees. After this point, the meeting media is rendered by the user devices (e.g., via the meeting applications) and not the room system.

Regarding the secret key 892, each secret key 892 may be unique for each meeting session and may be generated as a combination of device identifier, meeting identifier, user identifier, meeting room identifier, and/or time of day. This key may uniquely identify the user device to the conference server 102 so that the conference server 102 can prevent unauthorized replicated API (application programming interface) calls from a cloned device. The secret key 892 may also be used for logging or bookkeeping. For example, the secret key 892 may be included in records that log: switching events, to which devices content was streamed, at what time of day, and/or the conditions that caused a content switch.

In certain embodiments, the meeting applications may watermark or digitally fingerprint the meeting media rendered by the user devices by embedding the device-specific unique keys into the media, thus causing their respective renderings to be unique. Known techniques for media fingerprinting or watermarking may be used. The meeting server 101 may store, for example in a database table, associations between the user devices and their device-specific unique keys. Should any of the media rendered by a user device be shared outside of the meeting, the digital fingerprint can be used to trace the media back to the specific user device that rendered it.

After the rendering of the meeting media is transferred to the user devices, the room system may monitor the wireless connections (or signal strengths thereof) between the room system and the user devices. If a connection drops or sufficiently attenuates, then the user device may be deemed out of the locale of the meeting and streaming of the meeting media to the user device may be stopped. In one implementation, one type of media (e.g., WiFi) may be used for streaming the meeting media to the user devices, and another type of media (e.g., Bluetooth) may be used for determining whether a device is within a threshold range of the meeting locale or the room system. The monitoring of user devices may include regular health checks of the user devices or checking to determine if the cameras or microphones of the user devices are being used.

When the meeting server 101 determines to exit the privacy mode, the meeting server 101 may similarly signal the room system and user devices to switch to rendering the meeting media by the room system.

In some embodiments, the meeting server 101 may track which user device is associated with a moderator (or designated attendee) of a meeting. The meeting application on at least the user device operated by the moderator may be configured to allow the moderator to manually control, based on messages from the meeting server 101, whether the privacy mode is to be exited or entered, and consequently, whether media rendering should be transferred to or from the user devices. When the meeting server 101 determines to enter or exit the privacy mode, the meeting server may communicate with the moderator's meeting application to obtain a manual confirmation that media should be switched to or from user devices. The moderator's meeting application may also be configured to allow the moderator to manually instruct the meeting server 101 to enter or exit the privacy mode at any time, regardless of the privacy conditions of the meeting. In short, a moderator of a meeting may confirm content switching or may manually override or initiate transferring meeting media either to or from the user devices of the meeting.

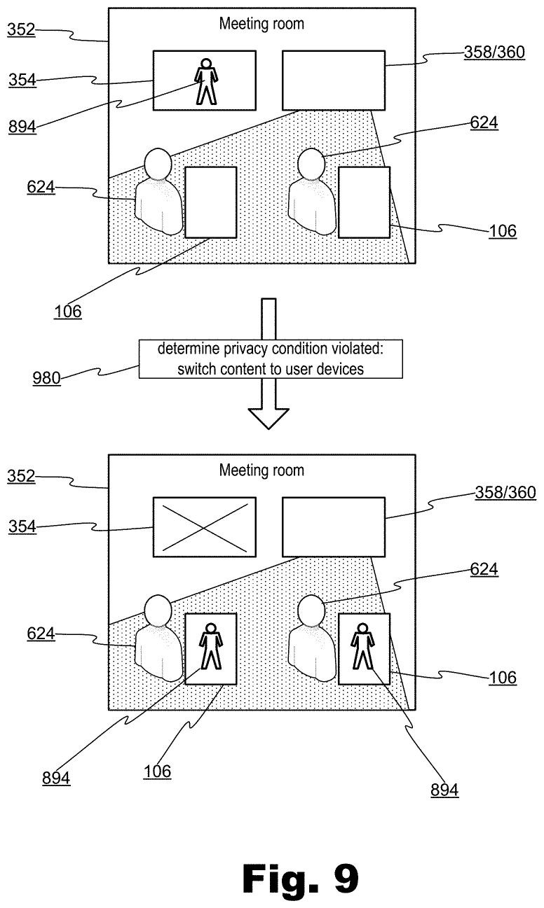

FIG. 9 shows rendering of meeting media 894 being shifted from a meeting room display 354 to user devices 106 of users 624 authorized to attend the meeting. Initially, at the top of FIG. 9, the meeting is not in the privacy mode and the display 354 of the room system 104 is displaying the meeting media 894 on the display 354 of the room system 104. The meeting media 894 may be provided by the conference server 102, a user device of an attendee, the room system 104, or any other source. A scan by the microphone 360 or camera 358 of the room system 104, for example, is processed to detect faces or voices of attendees, for example. A detected face or voice is determined to not be associated with any authorized attendee, a privacy condition is therefore determined 980 to be violated, and the meeting is put in the privacy mode. As shown at the bottom of FIG. 9, this causes the meeting media 894 to stop being displayed by the display 354 and start being displayed by the user devices 106 of the attending users 624. If the meeting media 894 includes audio data then the meeting system 100 may cause a speaker of the room system 104 to stop playing the audio data and may cause the attending user devices 106 to begin playing the audio data. The meeting media 894 may include only audio data in some examples.

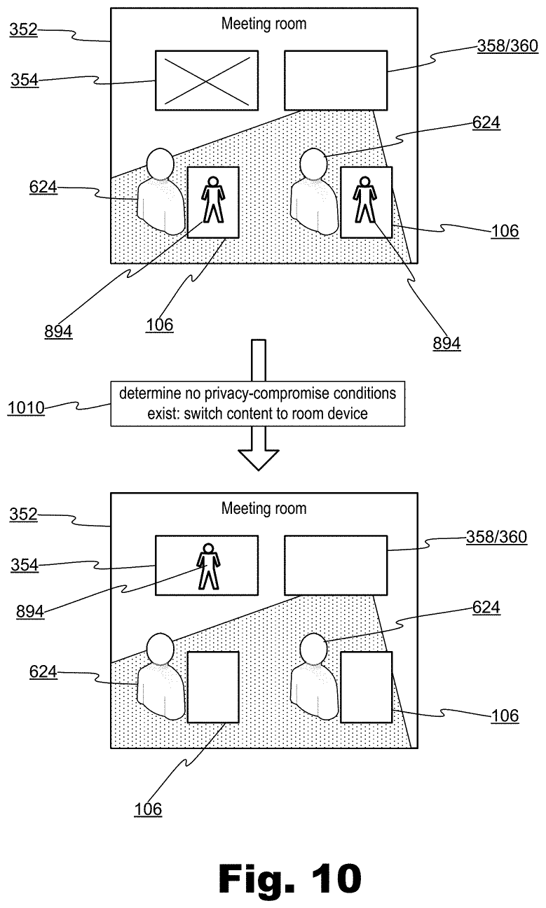

FIG. 10 shows rendering of meeting media 894 being shifted from user devices 106 to a meeting room display 354. Initially, at the top of FIG. 10, the meeting is in the privacy mode and the user devices 106 are displaying the meeting media 894. A scan by the microphone 360 and/or camera 358 of the room system 104, for example, is processed to detect faces and/or voices of attendees, for example. None of the detected faces and/or voices are determined to be unauthorized and therefore it is determined 1010 that no privacy conditions are being violated and the meeting is taken out of the privacy mode. As shown at the bottom of FIG. 10, the meeting system 100 causes the meeting media 894 to stop being displayed by the user devices 106 of the attending users 624 and causes the meeting media 894 to start being displayed by the display 354 of the room system 104. If the meeting media 894 includes audio data then the meeting system 100 may cause the user devices 106 to stop playing the audio and may cause a speaker of the room system 104 to start playing the audio data.

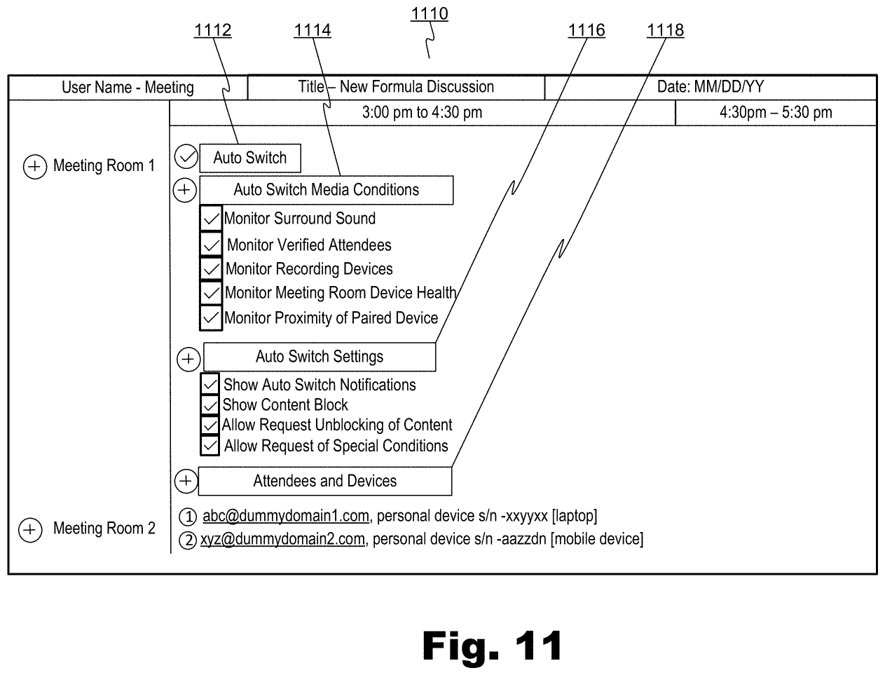

FIG. 11 shows an example of a user interface 1110 for configuring privacy-enhanced meetings. The user interface 1110 may be displayed by any computing device communicating with the meeting server 101. Meeting parameters of a meeting configured with the user interface 1110 may be stored in the meetings table 222. The user interface 1110 may include an element 1112 for enabling auto-switching of content during a meeting. Activating the element 1112 may display first settings 1114, second settings 1116, and third settings 1118. The first settings 1114 may be selected to set privacy conditions for the meeting being configured. In addition to privacy conditions described above, other privacy conditions may be provided, for example, requiring verification of the health of attendee's user devices. The second settings 1116 allow the user configuring the meeting to control how auto-switching of media is to be performed during the meeting. For example, notifications may be turned on (when an auto-switch occurs notifications may be displayed by the room system or user devices), a graphic may be displayed by the room system to indicate that media is being blocked from the room system, manual overriding of the privacy mode may be enabled, and a request for special conditions may be enabled. Special conditions may be user-defined custom requests that can be set, for example ‘show low battery notifications’ or ‘override content display over other applications’. The third settings 1118 may be used to select attendees for the meeting, for example from the user table 212.

In some embodiments, there may be settable preferences for the privacy mode. For example, a meeting administrator or sponsor may choose and select the privacy mode for certain meetings based on certain preset selections or options before sending out invitations to a meeting. These selections/options may also be customized per-meeting-room. As mentioned above, the conference rooms table 220 may include (or be linked to) sets of privacy options associated with respective rooms. For example, the types of privacy options available for a meeting may depend on the specific room, the equipment in the room, etc., and the privacy options in one room's set of privacy options may differ from the privacy options of another room. The user interface 1110 may be configured to display, in a selectable form, the privacy options that are associated with whichever room has been selected for a meeting. In some embodiments, if a privacy mode is selected, the privacy options of the corresponding room may be automatically applied as settings for the meeting. Such privacy settings may be applied before invitations are sent for the meeting, before the meeting begins, or during the meeting (for example in response to a moderator activation input).

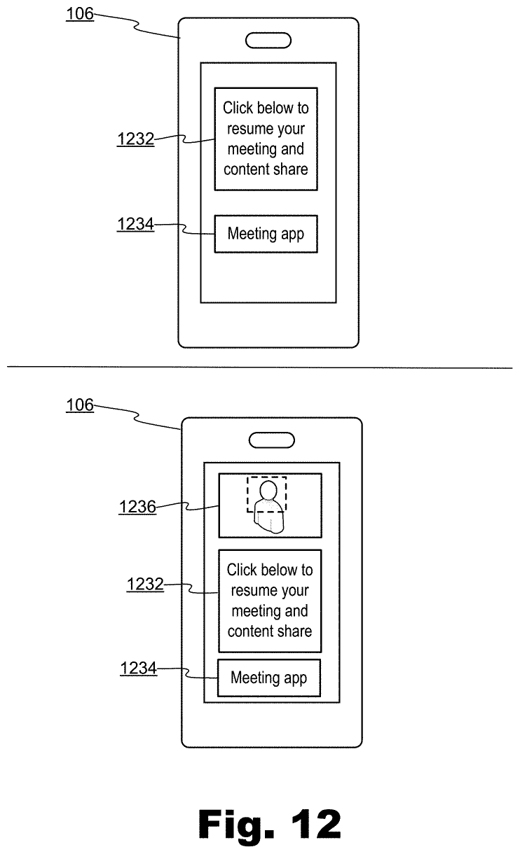

FIG. 12 shows examples of user interfaces for user devices 106. In the upper example of FIG. 12, a user device 106 responds to a signal indicating that the media of a meeting is being auto-switched to the user devices of the meeting by displaying on its display a notification 1232 instructing the user to select a link or icon 1234 for the meeting application 486. When the icon 1234 is selected the meeting application 486 is activated and begins receiving and rendering the media for the meeting. The lower example of FIG. 12 shows video 1236 being captured by the user device's front-facing camera. The video may be captured and sent to the meeting server 101 to verify the user before the user device begins receiving the meeting's media.

The meeting system 100 shown in FIG. 1 is one of many possible architectures for implementing meeting privacy functionality described herein. The division of functionality among components of the meeting system 100 is for convenience; some functions may be performed by other components, and some components may be omitted. For example, the privacy functionality may be implemented primarily by the room system, which may be configured for processing scans of a meeting locale, determining whether privacy conditions are met or not, and auto-switching where meeting media is rendered. Any or all of the functionality may be implemented by one or more cloud services communicating with a room system. In other embodiments, all of the meeting and privacy functionality may be implemented by user devices, and one user device may function as the privacy monitor and enforcer.

In some embodiments, the meeting applications on user devices associated with a meeting are configured to optionally render meeting media while a meeting is not in the privacy mode, and entering or exiting the privacy mode causes the room system to respectively stop and start rendering the meeting media. In other words, user devices are able to render meeting media while the room system is also rendering the meeting media.

In some embodiments, any type of meeting room condition that can be evaluated against monitoring by the room system may be used to control exiting and entering the privacy mode.

The meeting system 100 may contain a machine learning model that detects privacy breaches at specific meeting rooms. In addition, the database 210 (or one or more tables thereof) may be hosted at a multi-access edge compute (MEC) server system such as a private 5G MEC (mobile edge computation) system provisioned to an enterprise, which may provide secure and fast (e.g., low latency) privacy detection and remediation.

In some implementations, one or more of the systems, methods, and/or operations described herein may be implemented by one or more components of a cloud and/or MEC system, such as a MEC system of a provider network. A provider network (e.g., a nationwide or global wireless provider network) may include MEC resources implemented on various MEC servers distributed to various MEC nodes throughout the network. For example, Service Access Points (SAPs), Transport Access Points (TAPs), Radio Access Networks (RANs), and/or other components within the provider network, as well as distributed computing nodes associated with other networks such as peering networks or the Internet, may all serve as potential MEC nodes to which the computing resources of MEC servers are distributed.

A MEC server may refer to various computing resources at a given MEC node, whether those resources are integrated into a single server computer or a plurality of server computers operating at the same site or as part of the same MEC node. For example, a MEC server may refer to any set of computing resources (e.g., a server, a blade server, an edge server, a set of servers at a single site, etc.) that is accessible to multiple client devices and distributed in a manner that puts the resources at the edge of a network (e.g., the provider network, a peering network, another network associated with the Internet, etc.) to limit latency times, backhaul demands, and so forth.

In some implementations, the provider network may be implemented as a provider-specific wired or wireless communications network (e.g., a cellular network used for mobile phone and data communications, a 5G network or network of another suitable technology generation, a cable or satellite carrier network, a mobile telephone network, a traditional telephone network, etc.), and may be operated and managed by a provider entity such as a mobile network operator (e.g., a wireless service provider, a wireless carrier, a cellular company, etc.). The provider of the provider network may own or control all the elements necessary to deliver communications services to users of user equipment devices, including radio spectrum allocation, wireless network infrastructure, back haul infrastructure, customer care, provisioning of devices, and so forth.

In some implementations, one or more operations described herein (e.g., latency sensitive operations) may be performed by one or more MEC resources of a provider network, and one or more other operations described herein (e.g., more latency tolerant operations) may be performed by cloud resources. In some examples, one or more operations described herein for determining privacy conditions for a meeting may performed by MEC resources. In some examples, one or more operations described herein for switching content of a meeting from a room system to user devices or from user devices to the room system may be performed by MEC resources.

In some implementations, one or more of the systems, methods, and/or operations described herein may be implemented by one or more components of a communications network such as a 5G, LTE, or other provider wireless network. In some examples, one or more of the operations described herein may be performed by one or more components of a 5G new radio (NR) wireless network, such as a User Plane Function (UPF) node, a Session Management Function (SMF) node, an Access Management Function (AMF) node, and/or a 5G NR Radio Access Network (RAN) (e.g., base band units (BBUs) and/or remote radio heads (RRHs) of the 5G RAN). In some examples, one or more of the operations described herein may be performed by one or more components of an LTE network, such as a Packet Gateway node (P-GW), a Serving Gateway node (S-GW), a Mobility Management Entity node (MME), and/or an LTE RAN (e.g., BBUs and/or RRHs of the LTE RAN). In some examples, one or more of the operations described herein may be performed by one or more components of an Internet Protocol Multimedia System (IMS) network, such as a Proxy Call Session Control Function (P-CSCF), a serving Call Session Control Function (S-CSCF), an Interrogating Call Session Control Function I-CSCF, and/or a Home Subscriber Server (HSS).

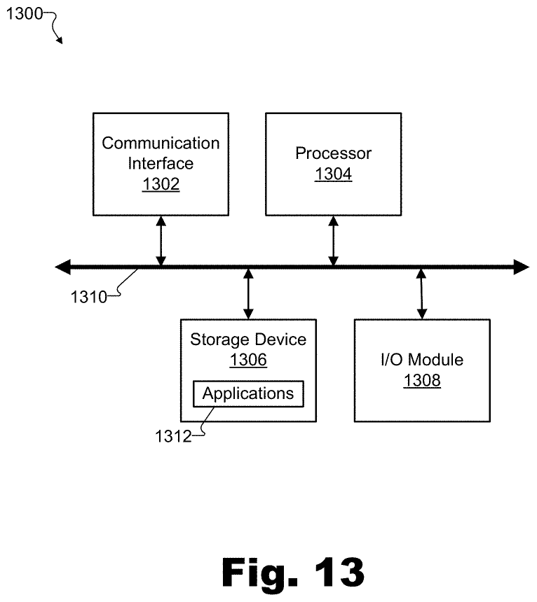

FIG. 13 shows a computing device 1300 that may be configured to perform one or more of the processes described herein. For example, one or more instances of the computing device 1300 may include or implement (or partially implement) a meeting system such as meeting system 100, a user device 106, and/or any other computing devices described herein. The computing device 1300 may be implemented as a virtual machine, for example hosted in a cloud computing environment, and “computing device” as used herein may refer to physical machines and/or virtual machines.

As shown in FIG. 13, computing device 1300 may include a communication interface 1302, a processor 1304, a storage device 1306, and an input/output (“I/O”) module 1308 communicatively connected via a communication infrastructure 1310. While an illustrative computing device 1300 is shown in FIG. 13, the components illustrated in FIG. 13 are not intended to be limiting. Additional or alternative components may be used in other embodiments. Components of the computing device 1300 shown in FIG. 13 will now be described further.

The communication interface 1302 may be configured to communicate with one or more other computing devices. Examples of the communication interface 1302 include, without limitation, a wired network interface (such as a network interface card), a wireless network interface (such as a wireless network interface card), a modem, an audio/video connection, and any other suitable interface.

The processor 1304 generally represents any type or form of processing unit capable of processing data or interpreting, executing, and/or directing execution of one or more of the instructions, processes, and/or operations described herein. The processor 1304 may direct execution of operations in accordance with one or more applications 1312 or other computer-executable instructions such as may be stored in the storage device 1306 or another computer-readable medium.

The storage device 1306 may include one or more data storage media, devices, or configurations and may employ any type, form, and combination of data storage media and/or device (the storage device 1306 is not a signal per se). For example, storage device 1306 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1306. For example, data representative of one or more executable applications 1312 configured to direct the processor 1304 to perform any of the operations described herein may be stored within the storage device 1306. In some examples, data may be arranged in one or more databases residing within the storage device 1306.

The I/O module 1308 may include one or more I/O modules configured to receive user input and provide user output. One or more I/O modules may be used to receive input for a single virtual experience. The I/O module 1308 may include any hardware, firmware, software, or combination thereof supportive of input and output capabilities. For example, the I/O module 1308 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

The I/O module 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O module 1308 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of the computing device 1300. For example, one or more applications 1312 residing within storage device 606 may be configured to cause the processor 1304 to perform one or more processes or functions associated with the meeting system 100, one or more components of the meeting system, or any implementation thereof. Likewise, the memory of one or more components of the meeting system 100 may be implemented by or within the storage device 1306.

To the extent that the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
determining, by a meeting system, a set of authorized identities, the authorized identities comprising identities determined to be authorized with respect to a meeting;
controlling, by the meeting system, whether to enter a privacy mode of the meeting based on repeatedly detecting identities present at a locale of a display, the detected identities comprising identities determined to be present at the locale of the display;
entering, by the meeting system, the privacy mode when a detected identity is determined to not be in the set of authorized identities; and
when the privacy mode is entered, causing, by the meeting system, media content associated with the meeting to stop being displayed by the display, and causing the media content to start being displayed on user devices associated with the respective authorized identities.

2. The method according to claim 1, wherein the detecting the identities present comprises capturing images of the meeting, extracting representations of faces from the images, and comparing the extracted representations of faces with representations of faces associated with respective user identities.

3. The method according to claim 1, wherein the detecting the identities present comprises detecting signals of devices to determine identities of the devices or determining user identities associated with audio data of voices captured at the meeting.

4. The method according to claim 1, further comprising prior to sending invitations to the meeting, receiving a setting input associated with the privacy mode, wherein the setting input indicates one or more settings for the privacy mode, and wherein the setting input is selected from among a set of options.

5. The method according to claim 4, further comprising storing associations between sets of options and respective meeting rooms, and wherein the set of options is selected from among the sets of options based on a meeting room of the meeting.

6. The method according to claim 1, further comprising:
when the privacy mode is entered:
causing a camera of a user device to capture an image of a face of an operator of the user device; and
determining, based on the captured image of the face, to cause the user device to display the media content.

7. A system comprising:
one or more processors configured to perform a process, the process comprising:
causing a display or speaker at a locale of a meeting of authorized attendees to render media content associated with the meeting, wherein the attendees have respective user devices;
determining that a person is present at the locale who is not authorized to attend the meeting; and
based on the determining that the unauthorized person is present at the locale, automatically causing the media content to switch from being rendered by the display or speaker to being rendered by the user devices.

8. The system according to claim 7, wherein the determining that a person is present at the locale who is not authorized to attend the meeting comprises:
capturing an image or video clip of the locale of the meeting;
detecting a representation of a face within the captured image or video clip; and
determining that the detected representation of the face does not correspond to a representation of a face of any person authorized to attend the meeting.

9. The system according to claim 7, wherein the determining that a person is present at the locale who is not authorized to attend the meeting comprises:
capturing an audio sample of the locale of the meeting; and
determining that a voice in the audio sample does not correspond to a voice of any person authorized to attend the meeting.

10. The system according to claim 7, the process further comprising:
determining that there is no person present at the locale who is not authorized to attend the meeting; and
causing, based on the determining that there is no person present at the locale who is not authorized to attend the meeting, the display or speaker to begin rending the media content.

11. The system according to claim 7, wherein the determining that a person present at the locale who is not authorized to attend the meeting comprises:
identifying identities present at the local of the meeting; and
determining that one of the identified identities is not in a set of identities authorized to attend the meeting.

12. The system according to claim 7, wherein the process further comprises providing keys to the respective user devices, wherein each key is unique with respect to the other keys; and wherein the media content is fingerprinted according to the keys before being rendered by the respective user devices.

13. The system according to claim 7, wherein:
the process further comprises accessing device-authorization information indicating which devices are authorized with respect to the meeting;
the scanning comprises receiving radio transmissions from a device in the locale of the meeting; and
the determining comprises determining, based on the device-authorization information and the radio transmission, that the device is not authorized for the meeting.

14. The system according to claim 7, wherein the process further comprises:
determining, based on the scanning, that no persons detected at the locale of the meeting are not authorized to attend the meeting; and
automatically causing, based on the determining that no persons detected at the locale of the meeting are not authorized to attend the meeting, the media content to switch from being rendered by the user devices to being rendered by the display or speaker.

15. The system according to claim 7, wherein the user devices comprise respective meeting applications that perform the rendering of the media content.

16. The system according to claim 15, wherein the meeting applications are configured to enable verification of respective attendees of the meeting, and wherein a meeting application is caused to begin rendering the media content based on verification of a respective attendee.

17. A non-transitory computer-readable medium storing instructions configured to, when executed by one or more computing devices, cause the one or more computing devices to perform a process, the process comprising:
periodically scanning a locale of a room system, wherein the room system is rendering media associated with a meeting of persons at the locale of the room system;
determining, based on the scanning, that a person at the locale is not authorized with respect to the meeting; and
based on the determining, causing the room system to stop rendering the media and causing user devices of the respective persons to begin rendering the media.

18. The non-transitory computer-readable medium according to claim 17, wherein the process further comprises:
determining, based on the scanning, that no persons at the locale are not authorized with respect to the meeting, and based thereon, causing the room system to begin rendering the media.

19. The non-transitory computer-readable medium according to claim 17, wherein the scanning comprises capturing, by the room system, video or images of the persons at the locale of the room system.

20. The non-transitory computer-readable medium according to claim 17, wherein the determining comprises comparing a result of the scanning with information associated with the persons.
